(19) United States
(12) Patent Application Publication
(10) Pub. No.: US 2003/0201352 A1
(43) Pub. Date: Oct. 30, 2003

(54) Guide wheel cap for tub grinder

(76) Inventor: Paul R. Gray, New Providence, IA (US)

Correspondence Address: DAVIS, BROWN, KOEHN, SHORS & ROBERTS, P.C., THE FINANCIAL CENTER, 666 WALNUT STREET, SUITE 2500, DES MOINES, IA, 50309-3993, US

(21) Appl. No.: 10/134,581

(22) Filed: Apr. 29, 2002

(51) Int. Cl. B02C 13/286

(52) U.S. Cl. 241/186.4

(57) ABSTRACT

The present invention intends to overcome the difficulties encountered heretofore. To that end, a size reducing machine with a rotating tub having a guide wheel with a cover for rotateably engaging the rotating tub is provided. The machine comprises a rotating tub having an open top, side walls, and a floor with an opening located therein, a rotary hammermill located substantially below the opening in the floor of the rotating tub, a drive mechanism for rotating the tub, a frame for operationally supporting the frame and the drive mechanism, a guide wheel rigidly attached to the frame and rotateably engaged with the rotating tub, and a guide wheel cover for protecting operational components of the guide wheels from failure induced by accumulation of debris from the size reducing machine and surrounding environment.

### BACKGROUND OF THE INVENTION

The present invention relates to a size-reducing machine with a rotating tub having a guide wheel with a cover for rotateably engaging the rotating tub, and in particular to a guide wheel cover that protects the guide wheel from failure resulting from the accumulation of operational and/or environmental debris associated with size reducing machines.

Size reducing machines, or comminuting machines, like tub grinders are well known in the art. These types of machines are typically quite large and powerful, and are used in a wide variety of settings to size reduce organic material such as wood, brush, grass, leaves, or for size reducing demolition debris.

Typically, the machines include a large rotating tub with an open top, side walls, and a floor with an opening located to one side. A vertically mounted grinding apparatus, like a rotary hammermill, is located below the opening in the floor such that the top of the hammer tips located on the hammermill extend just above the opening in the floor. A conveyor or mechanical arm loads waste material into the rotating tub. As the tub rotates the material encounters the hammer tips of the hammermill, which rotates at very high speeds. The hammermill rapidly and violently comminutes the wastes material. An appropriately sized screen allows the sized reduced material to pass through the tub to an auger or conveyor for final disposal. Often, tub grinders mount to a trailer pulled by a large semi-tractor to provide for moving the machines from site to site.

The rotating tub is supported by a frame that also supports a drive mechanism that rotates the tub. The point of engagement between the rotating tub and the frame characteristically comprises a plurality of guide wheels. The guide wheels rigidly attach to the frame, while at the same time engaging the tub in a manner that allows the tub to rotate. Specifically, tub grinders can include both vertically orientated guide wheels that engage a lip on the tub, and horizontally orientated guide wheels that engage the side wall of the tub.

Due to the nature of the operation of size reducing machines, failure and replacement of the components of the machine is quite common. In particular, the operation of the machine scatters debris over a wide area, and the environments that the machines operate often include a high amount of debris and dirt. Furthermore, the machines are open to environmental effects like rain and snow. The accumulation of this residual debris comprises one of the mechanisms of failure. This is especially true with regard to the guide wheels. Prior art guide wheels utilize some sort of an internal bushing or bearing surrounded by a wheel. An axle passes through the bushing or bearing and then secures to the frame. Residual debris often lodges in the guide wheels, especially the horizontally mounted guide wheels, and works its way into the bushing or bearings causing them to fail, and requiring replacement.

Thus, a need exists for a tub grinder with guide wheels that better resist the effects of residual environmental and operational debris.

### SUMMARY OF THE INVENTION

An object of the present invention comprises providing a size-reducing machine with a rotating tub having a guide wheel with a cover for rotateably engaging the rotating tub that resists the effects of residual environmental and operational debris.

These and other objects of the present invention will become apparent to those skilled in the art upon reference to the following specification, drawings, and claims.

The present invention intends to overcome the difficulties encountered heretofore. To that end, a size-reducing machine with a rotating tub having a guide wheel with a cover for rotateably engaging the rotating tub is provided. The machine comprises a rotating tub having an open top, side walls, and a floor with an opening located therein, a rotary hammermill located substantially below the opening in the floor of the rotating tub, a drive mechanism for rotating the tub, a frame for operationally supporting the frame and the drive mechanism, a guide wheel rigidly attached to the frame and rotateably engaged with the rotating tub, and a guide wheel cover for protecting operational components of the guide wheels from failure induced by accumulation of debris from the size reducing machine and surrounding environment.

### BRIEF DESCRIPTION OF THE DRAWINGS

FIG. 1 shows a top view of a prior art tub grinder.

FIG. 2 shows a top view of another prior art tub grinder.

FIG. 3 shows a side view of a portion of the prior art tub grinder of FIG. 2.

FIG. 4a shows a top view of a prior art guide wheel.

FIG. 4b shows a side section view of the prior art guide wheel.

FIG. 5a shows a side view of a guide wheel and cover.

FIG. 5b shows a side section view of the guide wheel and cover.

FIG. 6a shows a side view of the guide wheel cover.

FIG. 6b shows a top view of the guide wheel cover.

### DETAILED DESCRIPTION OF THE INVENTION

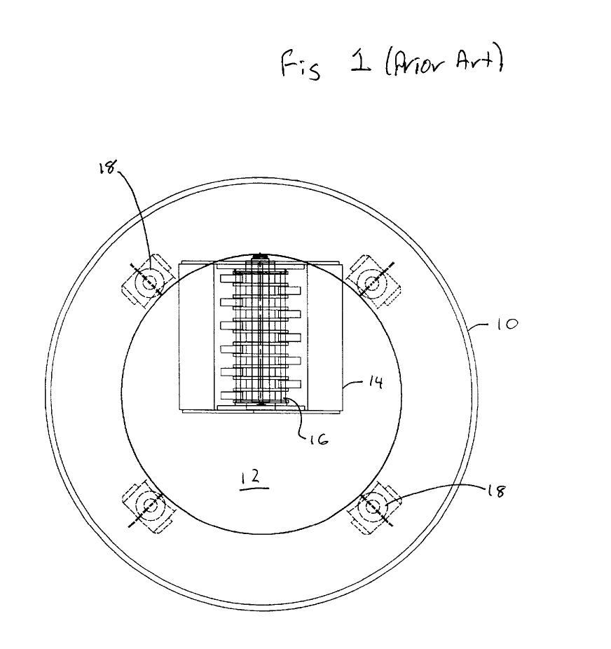

In the Figures, FIG. 1 shows a top view of a portion of a prior art tub grinder of the type disclosed in U.S. Pat. No. 5,950,942—hereby incorporated by reference. FIG. 1 shows a rotating tub 10 with side walls that taper to a floor 12. The floor 12 includes an opening 14 for operable communication with a rotary hammermill 16. Located adjacent to the side walls of the tub 10 are a plurality of horizontal guide wheels 18 that are rigidly affixed to a frame (not shown) that supports the guide wheels 18, and in turn the rotating tub 10.

As disclosed herein above, in operation debris is loaded into the rotating tub 10. As the tub 10 rotates the debris encounters the rotary hammermill 16, which begins size reducing the debris by impact. The size reduced debris drops through opening 14 in the floor 12 of the rotating tub 10, and eventually through a screen (not shown) located below the hammermill 16. Even under the best of conditions residual environmental and operational debris will collect on the tops of the horizontal guide wheels 18, which will accelerate the process of deterioration.

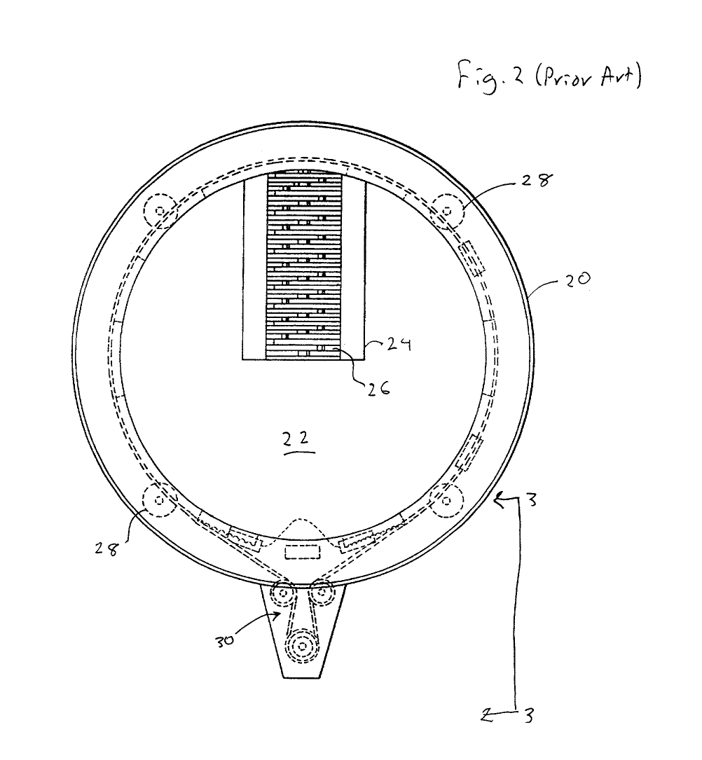

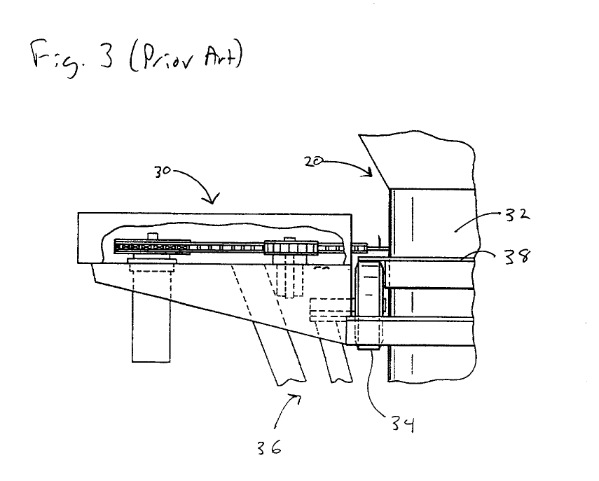

FIGS. 2-3 show a portion of another prior art tub grinder of the type disclosed in U.S. Pat. No. 5,419,502—hereby incorporated by reference. FIG. 2 shows a rotating tub 20 with a side wall 32 (see FIG. 3) that tapers to a floor 22. The floor 22 includes an opening 24 for operable communication with a rotary hammermill 26. Located adjacent to the side wall 32 of the tub 20 are a plurality of horizontal guide wheels 28 that are rigidly affixed to a frame 36 (see FIG. 3) that supports the horizontal guide wheels 28, and in turn the rotating tub 20. FIGS. 2-3 also show a drive mechanism used to rotate the tub 20, but is otherwise independent from the guide wheels 28. FIG. 3 shows a portion of the prior art tub grinder of FIG. 2, which includes a vertical guide wheel 34. The vertical guide wheel 34 is rigidly attached to frame members 36, and rotateably engaged with a lip 38 in the side wall 32 of the rotating tub 20.

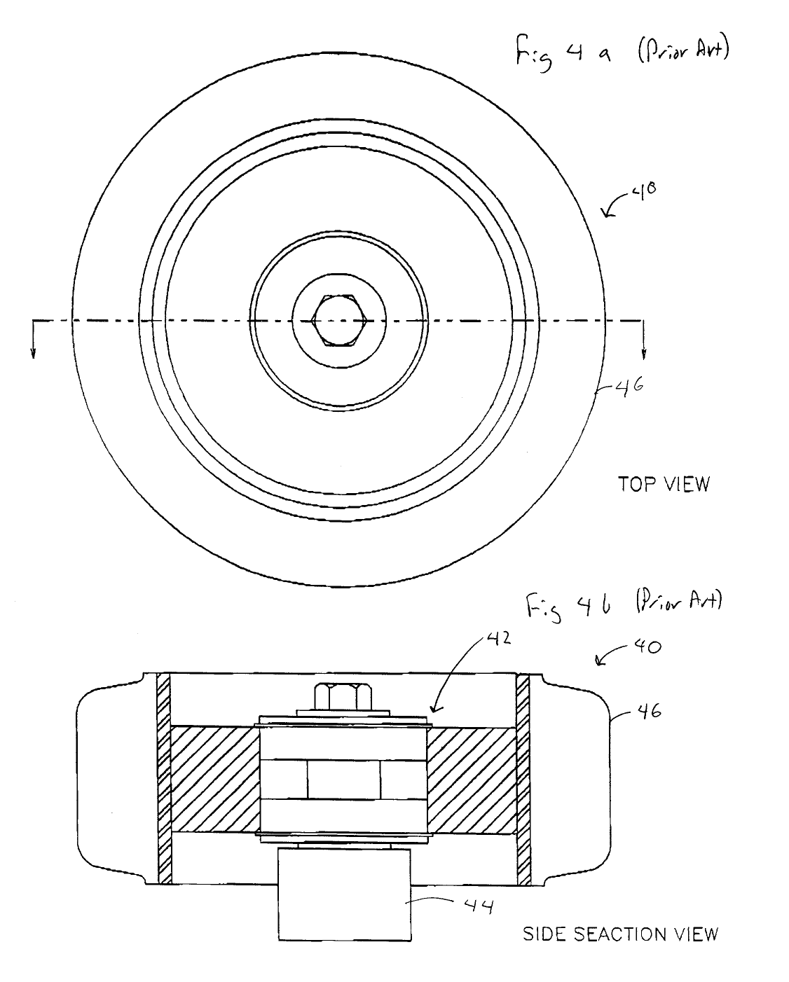

FIGS. 4a-b show a prior art guide wheel 40 that includes an interior bushing/bearing 42 mounted to an axle 44. The guide wheel 40 also includes an outer resilient surface 46 that rotateably engages the tub 10, 20. The prior art guide wheel 40, especially the horizontally mounted guide wheel 40, includes a region above the bushing/bearing 42 where environmental debris can accumulate. This debris eventually works its way into the interior of the guide wheel 40, and can cause the guide wheel 40 to fail.

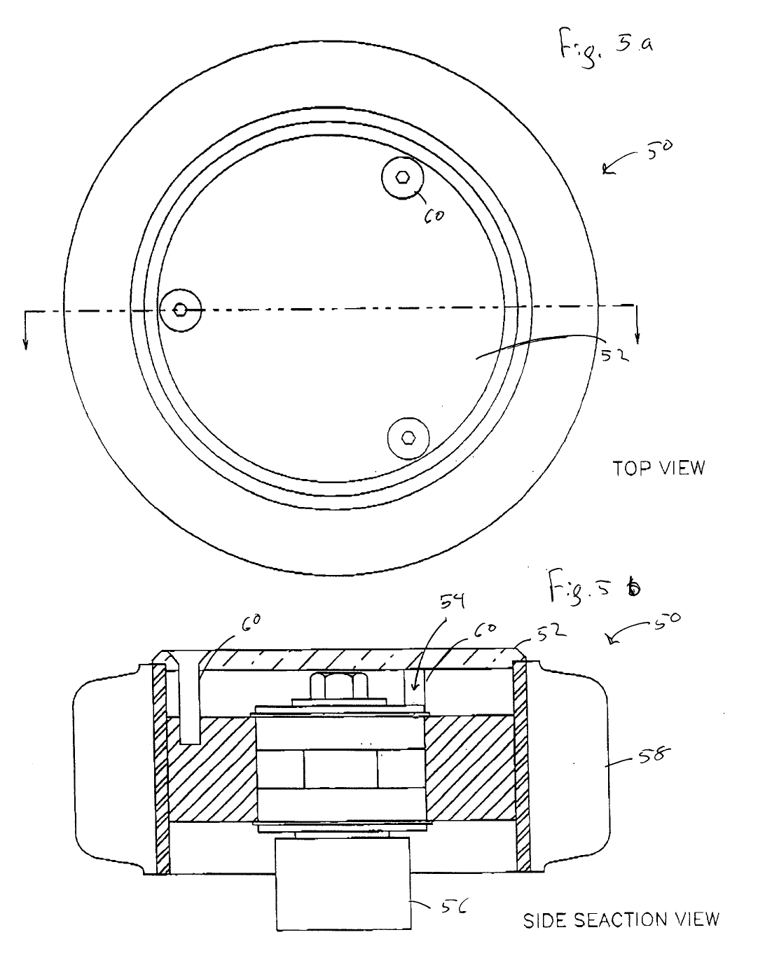

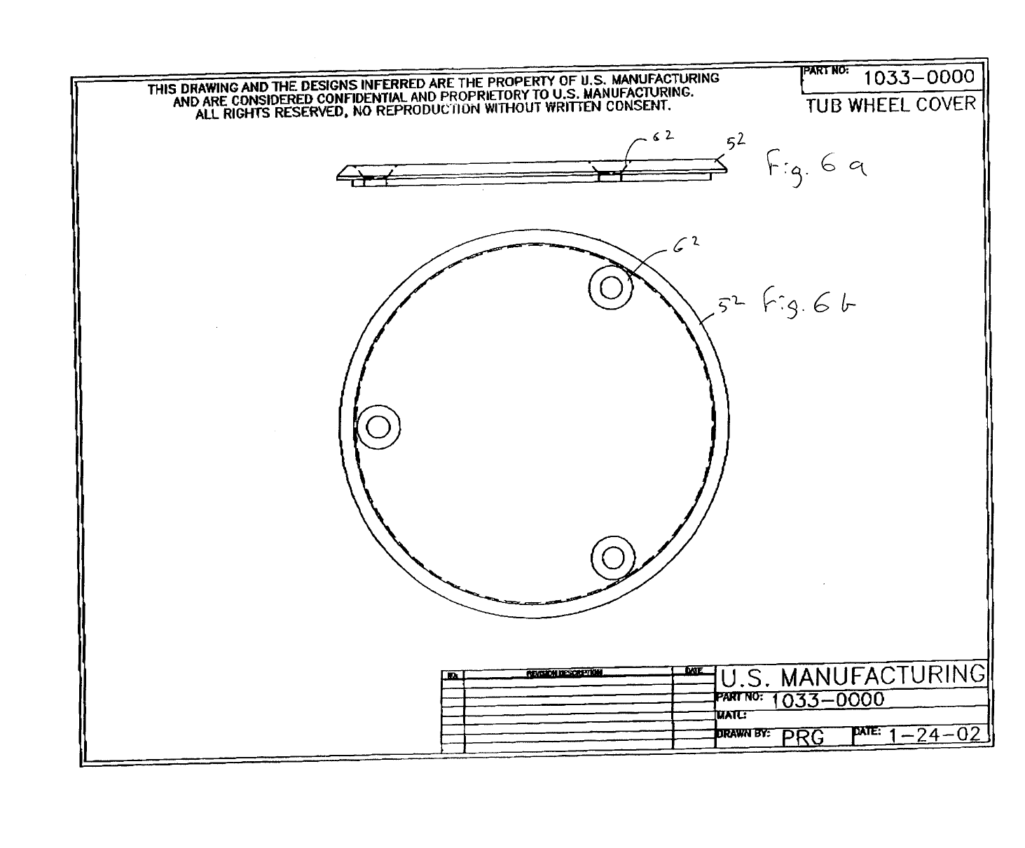

FIGS. 5-6 show an improved guide wheel 50 and cover 52 combination. The guide wheel 50 includes a bushing/bearing 54, axle 56, and an outer resilient surface 58 and functions in a manner identical to that described hereinabove. The guide wheel 50 further includes a guide wheel cover 52 that protects the inner workings of the guide wheel 50 from environmental and operational residual debris. The guide wheel cover 52 is attached to the guide wheel 50 with a three flat head screws 60 recessed into the guide wheel cover 52. In addition, a commercial silicone sealer can be used around the perimeter of the guide wheel cover 52, and around the screws 60, to form a watertight seal. The guide wheel 50 and guide wheel cover 52 combination will greatly extend the usable life of guide wheels, and in particular horizontally mounted guide wheels.

The foregoing description and drawings comprise illustrative embodiments of the present inventions. The foregoing embodiments and the methods described herein may vary based on the ability, experience, and preference of those skilled in the art. Merely listing the steps of the method in a certain order does not constitute any limitation on the order of the steps of the method. The foregoing description and drawings merely explain and illustrate the invention, and the invention is not limited thereto, except insofar as the claims are so limited. Those skilled in the art that have the disclosure before them will be able to make modifications and variations therein without departing from the scope of the invention.

1. A size reducing machine with a rotating tub having a guide wheel with a cover for rotateably engaging said rotating tub, said size reducing machine comprising:
a rotating tub having an open top, side walls, and a floor with an opening located therein;
a rotary hammermill located substantially below said opening in said floor of said rotating tub;
a drive mechanism for rotating said tub,
a frame for operationally supporting said frame and said drive mechanism;
a guide wheel rigidly attached to said frame and rotateably engaged with said rotating tub; and
a guide wheel cover attached to said guide wheel for protecting operational components of said guide wheels from failure induced by accumulation of debris from said size reducing machine and surrounding environment.

2. The invention in accordance with claim 1 further comprising a plurality of guide wheels and guide wheel covers.

3. The invention in accordance with claim 2 further comprising horizontal and vertical guide wheels.

4. The invention in accordance with claim 1 wherein said guide wheel cover is releaseably secured to said guide wheel with a plurality of screws.

5. The invention in accordance with claim 1 wherein said guide wheel cover is sealed with a sealant to form a substantially watertight seal.
